(19) United States
(12) Patent Application Publication
(10) Pub. No.: US 2007/0002679 A1
(43) Pub. Date: Jan. 4, 2007

(54) Liquid proportioning system

(76) Inventors: Vinayak G. Sharma, Arcadia, CA (US); Michael O. Long, Highland, CA (US); Charles W. George, Frenchtown, MT (US); Dan W. McKenzie, El Cajon, CA (US)

Correspondence Address: THOMPSON COBURN, LLP, ONE US BANK PLAZA, SUITE 3500, ST LOUIS, MO, 63101, US

(21) Appl. No.: 11/174,045

(22) Filed: Jul. 1, 2005

(51) Int. Cl. B01F 15/04

(52) U.S. Cl. 366/162.1; 366/163.2

(57) ABSTRACT

A liquid proportioning system controls the mixing of water and a fire retardant concentrate through the operation of a diaphragm operated valve. The diaphragm valve controls the flow rate of concentrate in response to the sensed pressure of water supplied to a proportioner, so that a predetermined proportion of concentrate and water is maintained.

### BACKGROUND OF THE INVENTION

(1) Field of the Invention

The present invention pertains to a liquid proportioning system that controls the mixing of one liquid, preferably water, with one or more other liquids. In particular, the present invention pertains to a fire retardant proportioning system in which a diaphragm-operated valve controls the flow rate of a fire retardant concentrate to a proportioner that mixes the concentrate with water. The diaphragm valve controls the flow rate of concentrate in response to the sensed pressure of water supplied to the proportioner and the sensed pressure of concentrate supplied to the proportioner so that a predetermined proportion of concentrate and water is maintained.

(2) Description of the Related Art

Specialized aircraft are often used in fighting forest fires and wild fires. These aircraft have large storage tanks that contain a liquid or fluid fire retardant that is dispensed by the aircraft as it flies over the area of a fire. The liquid fire retardant is typically a mixture of water and a liquid fire retardant concentrate. The water and fire retardant are mixed together in predetermined proportions to best suit the liquid mixture for extinguishing a fire.

It is desirable to mix a liquid fire retardant concentrate with water at a user location, and deliver the mixture directly to the aircraft. This is referred to as in-line blending or hot mixing. This eliminates a need for mixed retardant storage prior to use of the mixture. Storing the fire retardant concentrate alone makes more efficient use of available storage tanks than would storing the mixture of water and fire retardant.

The water and fire retardant concentrate are mixed at specified proportions, depending on the ingredients of the concentrate. However, the process of in-line blending of the water and fire retardant concentrate has some problems. There are a number of variables that can influence the accuracy of the proportioning of the water and fire retardant concentrate that make accurate control of the mixture ratio during in-line blending operations difficult. For example, differences in water and fire retardant concentrate pressures resulting from changes in the level of the liquids in their storage tanks, the speeds of the pumps pumping the liquids, the flow rate of the liquids being mixed, and the fire retardant concentrate viscosity all make in-line blending operations difficult.

Also, the density of liquid fire retardant concentrate is significantly greater than that of water (concentrates can be 50% heavier than water) and improper proportioning of the water and concentrate can result in overloading of the aircraft, presenting a serious safety issue.

An automatic system that is capable of providing accurately proportioned in-line blending of water and one or more other liquids, for example a fire retardant concentrate without frequent sampling and testing would provide a significant advance in fighting forest fires and wild fires with aircraft.

### SUMMARY OF THE INVENTION

The liquid proportioning system of the present invention is capable of proportioning together any two liquids and may be used in any application in which it is desired to control the proportioning of a first liquid, preferably water, mixed with one or more other liquids. For example, the system of the invention may be used in proportioning liquid fire fighting foams and water, enhancing gels with water and with liquid colorants, fire retardants and water, fire suppressants and water, fire retardant solutions and liquid colorant additives, foam forming liquids and water, etc. In the description of the invention to follow, the proportioning system of the invention is described as blending and proportioning a fire retardant concentrate and water. It should be understood that this description is illustrative of only one manner in which the proportioning system of the invention may be used, and is not intended to be limiting. The proportioning system of the invention can be used in other industries that proportion liquids together.

The difficulties encountered by in-line blending of water and liquid fire retardant concentrate are overcome by the fire retardant proportioning system of the present invention. The system basically comprises a venturi proportioner that is set at a predetermined mix ratio for water and a liquid fire retardant concentrate, depending on the characteristics of the fire retardant used.

A water pump and water conduit communicate a source of water with the proportioner. A fire retardant pump and fire retardant conduit communicate a source of fire retardant concentrate with the proportioner.

A diaphragm-operated valve controls the flow of fire retardant through the fire retardant conduit to the proportioner. The diaphragm of the valve senses the pressure of water in the water conduit on one side of the diaphragm, and senses the pressure of fire retardant in the fire retardant conduit on the opposite side of the diaphragm. Thus, the relative pressures of the water and fire retardant control the opening and closing of the valve. In this way, the pressures of the water and fire retardant being supplied to the proportioner remain proportionate, and variations in pressures of either or both of the water and fire retardant do not cause changes in the mix ratio of water and fire retardant exiting the proportioner.

In addition, if the flow of water supplied to the proportioner is limited or interrupted, the change in water pressure immediately causes the valve to close, thereby avoiding any unintended delivery of the fire retardant concentrate to the aircraft that could potentially lead to the overloading of the aircraft over safety limits.

### BRIEF DESCRIPTION OF THE PREFERRED EMBODIMENT

Further features of the invention are set forth in the following detailed description of the invention and in the drawing figures wherein:

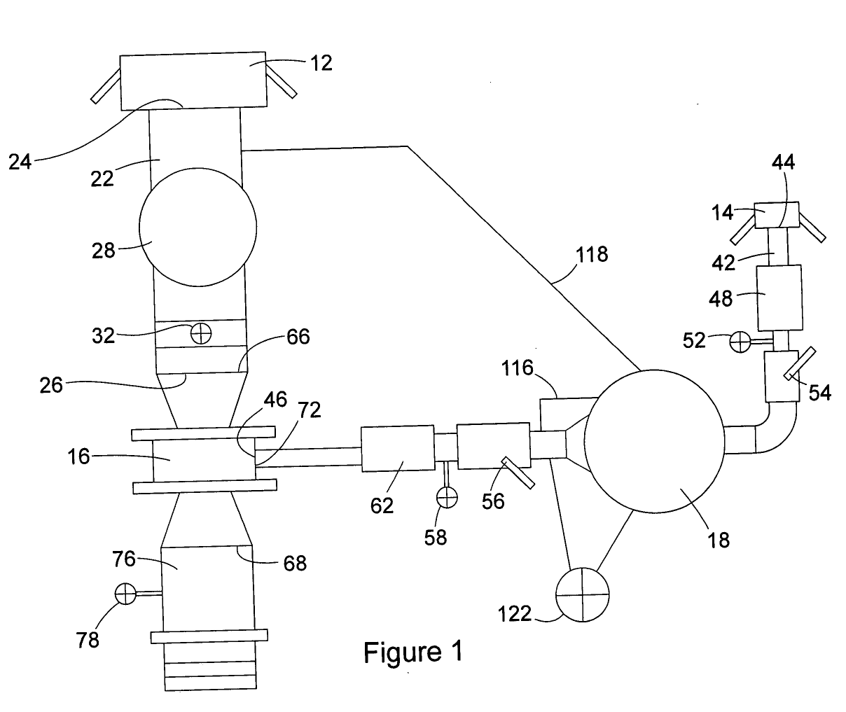

FIG. 1 is a schematic representation of the fire retardant proportioning system of the invention; and

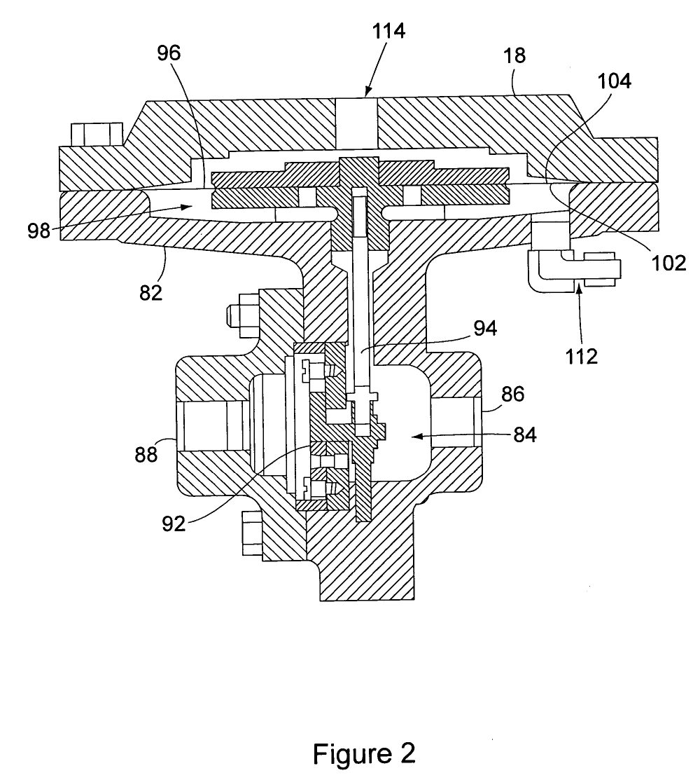

FIG. 2 is a cross-section view of a diaphragm-operated valve that is employed in the system of FIG. 1.

### DETAILED DESCRIPTION OF THE PREFERRED EMBODIMENT

As stated earlier, the liquid proportioning system of the present invention is capable of proportioning together any two liquids and may be used in any application in which it is desired to control the proportioning of a first liquid, preferably water, mixed with one or more other liquids. In the description of the invention to follow, the proportioning system of the invention is described as blending and proportioning a fire retardant concentrate and water. It should be understood that this description is illustrative of only one manner in which the proportioning system of the invention may be used, and is not intended to be limiting.

The present invention provides a system for in-line blending of water and at least one other second liquid, for example a fire retardant concentrate to produce a fire retardant mixture where the desired proportions of water and concentrate are maintained during blending despite variations in the pressures of the liquids or the flow rates of the liquids. The system of the invention combines known component parts in a novel arrangement to achieve the desired objective.

FIG. 1 shows a schematic representation of the fire retardant proportioning system of the invention. In general, the system shown in FIG. 1 comprises a source of water under pressure 12, a source of fire retardant concentrate under pressure 14, a liquid proportioner 16 that receives the water and concentrate and produces a mixture of the two at desired proportions, and a valve assembly 18 that controls the flow of concentrate to the proportioner. The specific constructions of these component parts of the system are known and will not be described in detail. In addition, although the preferred embodiment of the system shown in FIG. 1 communicates with a source of fire retardant concentrate, the system of the invention is equally well suited for use in mixing water with a fire retardant that is not concentrated, as well as with other fluids to produce a desired proportion of water with the other fluids.

The water source 12 communicates directly with the proportioner 16 through a length of water conduit 22. What is meant by “directly” is that there are no branch conduits other than those of the proportioning system communicating with the water conduit 22 between the water source 12 and the proportioner 16. The water conduit 22 has an input end 24 communicating with the water source 12, and an opposite output end 26 that communicates with the proportioner 16. Thus, the downstream flow of water received from the water source 12 is through the water conduit 22 from the input end 24 to the output end 26.

A check valve 28 is positioned along the water conduit 22 to ensure that the flow of water is only in the downstream direction. A pressure gauge 32 is also provided along the length of the water conduit 22. The pressure gauge 32 enables monitoring of the pressure of water flowing from the water source 12 to the proportioner 16.

A length of fire retardant conduit 42 directly communicates the fire retardant source 14 with the proportioner 16. Again, “directly” means that there are no branch conduits, other than those of the proportioning system, communicating with the fire retardant conduit 42 between the fire retardant source 14 and the proportioner 16. The fire retardant conduit 42 has an input end 44 that communicates with the fire retardant source 14 and an opposite output end 46 that communicates with the proportioner 16. Thus, the downstream flow of fire retardant through the fire retardant conduit 42 is from the input end 44 to the output end 46.

A check valve 48 is positioned along the length of the fire retardant conduit 42 adjacent to the fire retardant source 14. The check valve 48 ensures that the flow of fire retardant through the fire retardant conduit 42 is in the downstream direction. A pressured gauge 52 is positioned along the length of the fire retardant conduit 42 just downstream of the check valve 48. The pressure gauge 52 gives a visual indication of the pressure of fire retardant flowing through the fire retardant conduit 42 from the fire retardant source 14. A manually operated valve 54 is positioned along the fire retardant conduit 42 just downstream of the pressure gauge 52. The manually operated valve 54 provides a manual control of the flow of fire retardant through the fire retardant conduit 42. In the preferred embodiment, the manual valve 54 is a ball valve.

A second manual valve 56 is positioned along the length of the fire retardant conduit 42 to provide control of flow of fire retardant in the mix ratios as desired. Manual valve 56 can be calibrated and adjusted to a setting on the valve indicator to operate different liquids at different mix ratios. Various positions on the manual valve 56 can be marked on valve indicator to reflect settings for different liquids. This second manual valve is also preferably a ball valve. A second pressure gauge 58 is positioned downstream of the second manual valve 56, and a second check valve 62 is positioned downstream of the second pressure gauge 58.

The proportioner 16 is preferably a venturi type proportioner, for example an Ansul® proportioner produced by Ansul, Inc. of Marinette, Wis. The proportioner has an inlet end 66 that communicates with the water conduit output end 26. The proportioner inlet end 66 has the inlet nozzle of the proportioner. The length of the proportioner 16 directs the flow of liquid in the downstream direction through the proportioner from the proportioner inlet end 66 to an outlet end 68 of the proportioner. The proportioner has a metering orifice connection 72 along the proportioner length. The fire retardant conduit output end 46 communicates with the proportioner metering orifice connection 72.

A discharge conduit 76 communicates with the proportioner outlet end 68. A pressure gauge 78 is provided on the discharge conduit 76 to provide a visual indication of the pressure of the mixed liquid discharged from the proportioner 16 through the discharge conduit 76.

In the preferred embodiment of the system, the valve assembly 18 is a diaphragm operated valve, for example the Mark 66 pressure regulator valve manufactured by Jordan Valve of Cincinnati, Ohio. Because the construction of this type of valve is known in the art, the construction of the valve assembly 18 shown in FIGS. 1 and 2 is not described in detail.

Referring to FIG. 2, the valve assembly 18 has a housing 82 with an interior liquid conducting bore 84. The bore 84 extends in the downstream flow direction from an input end 88 of the bore to an output end 88 of the bore. The valve bore input end 88 communicates with the fire retardant conduit 42 and receives a flow of fire retardant from the fire retardant source 14. The valve bore output end 86 communicates with the proportioner 16 and delivers a flow of fire retardant to the proportioner.

Opening and closing of the valve housing bore 84 is controlled by a gate valve 92. The gate valve 92 is shown in it's open position in FIG. 2. The gate valve 92 is operatively connected through a rod 94 with a diaphragm 96 of the valve. The diaphragm 96 is contained in an interior diaphragm chamber 98 of the valve housing 82. The diaphragm has opposite first 102 and second 104 sides. The diaphragm first side 102 is operatively connected with the gate valve 92 through the rod 94.

A pair of inlets 112,114 communicate the interior diaphragm chamber 98 of the valve housing 82 with the exterior environment of the valve housing. The first inlet 112 communicates with a fire retardant pressure sensing conduit 116 shown in FIG. 1. The fire retardant pressure sensing conduit 16 extends from the first inlet 112 to the fire retardant conduit 42 just downstream of the valve assembly 18. Thus, the fire retardant pressure sensing conduit 116 communicates the first side 102 of the diaphragm 96 with the fluid pressure of the fire retardant in the fire retardant conduit 42 just downstream of the valve assembly 18.

A water pressure sensing conduit 118 extends between the second valve housing inlet 114 and the water conduit 22 just downstream of the water source 12. The water pressure sensing conduit 118 communicates the diaphragm second side 104 with the pressure of the water carried by the water conduit 22 just downstream of the water source 12.

Thus, the pressure of the fire retardant flowing through the fire retardant conduit 42 just downstream of the valve assembly 18 and the water flowing through the water conduit 22 just downstream of the water source 12 act on the respective first side 102 and second side 104 of the valve diaphragm 96. The differences in these pressures control the position of the gate valve 92 and in turn control the flow of fire retardant through the valve assembly 18.

A duplex gauge 122 is connected between the fire retardant conduit 42 just downstream of the valve assembly 18, and the diaphragm chamber 98 on the second side 104 of the diaphragm. The duplex gauge 108 provides a visual indication of the differences in the fluid pressures acting on the opposite sides of the diaphragm 96.

It can be seen from the description of the valve housing 82 and its connections to the fire retardant pressure sensing conduit 116 and water pressure sensing conduit 118 described above, that when water pressure drops in the water conduit 22 the gate valve 92 is moved to it's closed position, preventing a further flow of fire retardant through the valve assembly 18 and the fire retardant conduit 42 to the proportioner 16. In this way, the valve assembly 18 provides a safety feature that prevents the heavier fire retardant from being supplied to the proportioner 16 should the flow of water to the proportioner be stopped.

In use of the fire retardant proportioning system shown in FIG. 1 in loading fire retardant liquid on an aircraft or other types of vehicles, the discharge conduit 76 is first connected with the storage tank of the aircraft or other vehicle (not shown) and the aircraft or other vehicle loading valve (not shown) is opened to fill the storage tank. The water source 12 and fire retardant source 14 are then activated to supply water and fire retardant concentrate through the respective water conduit 22 and fire retardant conduit 42 to the proportioner 16, and proportioning of the two liquids begins.

In the valve assembly 18, the first side 102 of the diaphragm 96 is subjected to the pressure of the fire retardant in the fire retardant conduit 42 just downstream of the valve assembly 18. The second side 104 of the diaphragm 96 is subjected to the pressure of the water in the water conduit 22 just downstream of the water source 12. The differential pressure between the diaphragm first side 102 and the diaphragm second side 104 operates the gate valve 92 to dispense fire retardant concentrate through the valve housing bore 84. The valve assembly 18, and in particular the diaphragm 96, uses the pressure of the water discharged from the water source 12 to regulate the pressure of the fire retardant concentrate discharged from the valve assembly 18.

The size of the venturi in the proportioner 16 produces the product discharged through the discharged conduit 76 in the desired mixed ratio. The pressure of the water at the proportioner 16 and the pressure of the fire retardant at the proportioner 16 is kept equal due to the functioning of the valve assembly 18. This results in a stable mixed ratio of the two liquids produced by the proportioner over a long period of operation of filling the storage tank. In this manner, the liquid proportioning system of the invention overcomes the inconsistencies resulting from changes in head pressure, flow rate and pump performance.

Although the subject matter of the invention has been described above by reference to a particular embodiment, it should be understood that modifications and variations may be made to the invention without departing from the intended scope of protection provided by the following claims.

1. A liquid proportioning system comprising:
a source of a first liquid;
a first liquid conduit having an input end and an output end, the first liquid conduit input end communicating with the source of first liquid;
a source of a second liquid;
a second liquid conduit having an input end and an output end, the second liquid conduit input end communicating with the source of the second liquid and the second liquid conduit output end communicating with the first liquid conduit output end; and
a diaphragm operated valve in the second liquid conduit for controlling a flow of second liquid from the source of the second liquid through the second liquid conduit.

2. The system of claim 1, further comprising:
the diaphragm having opposite first and second sides, the diaphragm first side being operatively connected to the valve, and the diaphragm first side communicating with the second liquid conduit.

3. The system of claim 2, further comprising:
the diaphragm first side communicating with the second liquid conduit downstream from the diaphragm operated valve.

4. The system of claim 2, further comprising:
the diaphragm second side communicating with the first liquid conduit.

5. The system of claim 4, further comprising:
a liquid proportioner communicating with the first liquid conduit output end and the second liquid conduit output end.

6. The system of claim 5, further comprising:
the liquid proportioner having a venturi.

7. The system of claim 2, further comprising:
a liquid proportioner communicating with the first liquid conduit output end and the second liquid conduit output end.

8. The system of claim 2, further comprising:
a differential pressure gauge communicating with the first liquid conduit and the second liquid conduit.

9. The system of claim 8, further comprising:
the differential pressure gauge communicating with the second liquid conduit downstream from the diaphragm operated valve.

10. The system of claim 1, further comprising:
the second liquid being a fire retardant.

11. A liquid proportioning system comprising:
a proportioner that mixes a first liquid and a second liquid in a predetermined proportion;
a source of first liquid communicating with the proportioner, the first liquid having a first liquid pressure;
a source of the second liquid communicating with the proportioner; and,
a valve controlling a flow of the second liquid to the proportioner in response to the first liquid pressure.

12. The system of claim 11, further comprising:
the second liquid having a liquid pressure; and,
the valve controlling the flow of the second liquid to the proportioner in response to both the first liquid pressure and the second liquid pressure.

13. The system of claim 12, further comprising:
the valve controlling the flow of the second liquid to the proportioner in response to the second liquid pressure downstream of the valve.

14. The system of claim 13, further comprising:
the valve controlling the flow of the second liquid to the proportioner in response to the second liquid pressure upstream of the proportioner.

15. The system of claim 13, further comprising:
the valve controlling the flow of the second liquid to the proportioner in response to the second liquid pressure upstream of the proportioner.

16. The system of claim 11, further comprising:
a duplex or differential pressure gauge communicating with the source of first liquid and the source of the second liquid.

17. The system of claim 16, further comprising:
the duplex or differential pressure gauge communicating with the source of the second liquid downstream of the valve.

18. The system of claim 11, further comprising:
the second liquid being a fire retardant.

19. A liquid proportioning system comprising:
a proportioner that mixes a first liquid and a second liquid in predetermined proportions;
a source of first liquid communicating first liquid under pressure with the proportioner;
a source of second liquid communicating the second liquid under pressure with the proportioner; and,
means for controlling a rate of flow of the second liquid to the proportioner in response to the first liquid pressure.

20. The system of claim 19, further comprising:
the means for controlling the rate of flow of the second liquid also controlling the rate of flow of the second liquid in response to the second liquid pressure.

21. The system of claim 19, further comprising:
a differential pressure gauge communicating with the source of the first liquid and the source of the second liquid.

22. The system of claim 19, further comprising:
the second liquid being a fire retardant.
